(19) United States
(12) Patent Application Publication
(10) Pub. No.: US 2025/0285293 A1
(43) Pub. Date: Sep. 11, 2025

(54) METHODS OF AND APPARATUS FOR MOTION ESTIMATION

(71) Applicant: Arm Limited, Cambridge (GB)

(72) Inventors: Daren CROXFORD, Swaffham Prior (GB); Mina Ivanova DIMOVA, Great Shelford (GB); Roberto LOPEZ MENDEZ, Cambridge (GB)

(21) Appl. No.: 18/600,089

(22) Filed: Mar. 8, 2024

(51) Int. Cl. G06T 7/215; G06T 7/231; G06T 7/238; G06T 7/40; G06T 9/00

(52) U.S. Cl. CPC G06T 7/215; G06T 7/231; G06T 7/238; G06T 7/40; G06T 9/00; G06T 2207/20021

(57) ABSTRACT

A method of performing motion estimation for spatially arranged data in a data processor, the spatially arranged data having been previously compressed using a compression algorithm that generates compression meta data representing the spatially arranged data includes for a first region of the spatially arranged data: obtaining compression meta data for the first region, the compression metadata including smoothness information indicative of a smoothness of the first region; determining a search space size based on the obtained smoothness information, the search space size being a size of a search space for applying a region-matching motion estimation algorithm to the first region to match the first region with a corresponding region in reference spatially arranged data within the search space.

### FIELD

The present disclosure relates to methods and apparatuses for motion estimation, in particular motion estimation in graphics processing.

### BACKGROUND

In image processing, motion estimation, also known as optical flow, is used to determine motion vectors that describe the transformation from one set of spatially arranged data (e.g. an image frame, a portion of an image frame, texture data, depth information, etc.) to another, generally between sequential sets of spatially arranged data (frames) in a sequence of sets of spatially arranged data. In general, a search is performed for each region (e.g. a macroblock) of a current set of spatially arranged data, e.g. a current frame, to compare each region with one or more region in a reference set of spatially arranged data, e.g. a reference frame (e.g. a preceding frame). The search space, an area in the reference frame within which the search is performed, may differ but typically an area in the reference frame comprising a region corresponding in position to the region in question and one or more regions adjacent the corresponding region is set as the search space and compared with the region in question (in the current frame) for a match. In general, a larger search space increases the likelihood of finding a better matching corresponding region in the reference frame with respect to the region in question; however, more processing resources and energy as well as time is required to search a larger area. The best match region in the reference frame (e.g. a region with the smallest difference to the region in question) is then used to generate a motion vector that describes the movement of the elements within the region in question with respect to the previous frame. Mean Predictive Block Matching (MPBM) is an example of such a motion estimation algorithm.

Enhanced Mean Predictive Block Matching (EMPBM) is another example of motion estimation technique. In EMPBM, edge detection is performed prior to region/block matching to improve the overall speed (therefore reduce latency) of motion estimation for a frame and conserve processing energy and resources. The technique classifies a region (e.g. macroblock) of the current frame into either shade (smooth, featureless or minimally contrasting features such as background) or edge (contrasting features such as objects in the foreground). If the region is identified as edge, an algorithm is applied to an extended search space (i.e. the standard or normal search space set for the algorithm) to match the region with a corresponding region in the reference frame. However, recognizing that a region identified as shade has a high probability of generally moving in the same direction as adjacent regions, when a region is identified as shade, the search space can be reduced such that region/block matching is performed within a smaller area of the reference frame, such that the amount of computations is reduced.

However, in conventional motion estimation approaches such as MPBM and EMPBM, the reference frame (or at least portions of) must be retrieved from memory to enable region/block matching to be performed with respect to each region of the current frame.

There is, therefore, scope for improving motion estimation techniques in graphics processing.

### BRIEF DESCRIPTION OF THE DRAWINGS

Embodiments will now be described, with reference to the accompanying drawings, in which:

FIG. 1 shows schematically an exemplary system comprising a CPU and a GPU;

FIG. 2 shows schematically an exemplary GPU comprising processing circuitry for motion estimation;

FIG. 3 illustrates an exemplary region-matching motion estimation technique;

FIG. 4 illustrates the exemplary region-matching motion estimation technique using a reduced search space;

FIG. 5 illustrates an exemplary region-based compression scheme;

FIG. 6 shows an embodiment wherein a search macroblock overlaps two compression blocks;

FIG. 7 shows an embodiment wherein a region-based compression scheme generates compression blocks arranged in a hierarchy; and

FIG. 8 shows a flow diagram of an exemplary method of motion estimation.

### DETAILED DESCRIPTION

Motion estimation is computationally intensive, consuming significant amount of computation resources and energy as well as increasing latency. The increase in latency is particularly detrimental to applications where rendering demands a short motion-to-photon latency (e.g. neural super-sampling, augmented, extended, mixed or virtual reality, AR, XR, MR, VR).

While the use of techniques such as EMPBM improves the search efficiency of region matching motion estimation through reducing the computation requirement for a portion of a frame, such techniques still require each region of the frame to first be processed to determine if the region should be classified as edge or shade. This first processing step consumes computation resources and energy and contributes to latency, and additional hardware logic may be required in order to perform such first processing.

The present approach seeks to reduce latency as well as computation resources and energy requirements for motion estimation through reducing the amount of processing required to determine an appropriate search space for each region of a set of spatially arranged data when performing region matching. In doing so, region matching may be performed efficiently without incurring (or incurring less) additional processing to determine if a region is shade or edge.

An aspect of the present technology provides a method of performing motion estimation for spatially arranged data in a data processor, the spatially arranged data having been previously compressed using a compression algorithm that generates compression meta data representing the spatially arranged data, the method comprising: for a first region of the spatially arranged data: obtaining compression meta data for the first region, the compression metadata comprising smoothness information indicative of a smoothness of the first region; and determining a search space size based on the obtained smoothness information, the search space size being a size of a search space for applying a region-matching motion estimation algorithm to the first region to match the first region with a corresponding region in a reference frame within the search space.

According to embodiments of the present technology, when performing motion estimation (e.g. using a block-matching motion estimation algorithm such as EMPBM) for spatially arranged data (e.g. a frame or a portion of a frame) that has previously been compressed, compression meta data that includes information indicative of the smoothness of a region of the spatially arranged data is read, then the size of the search space for applying region matching with respect to the region is set based on the smoothness of the region. Herein, the term compression meta data simply refers to meta data related to the compressed frame or compressed portion of the frame, and is not indicative of any specific type of form of meta data. The Applicant has recognized that, in graphics processing, spatially arranged data (e.g. frames) are generally compressed to minimize bandwidth requirements, and that the associated compression meta data generally contains information that indicates the smoothness of different regions of the spatially arranged data. This smoothness information of a region may therefore be used, in a similar way to classifying a region as edge or shade, to set a search space for applying motion estimation to the region. Thus, the determination of a search space for a region of a frame may be performed by simply reading from the compression meta data smoothness information for that region without (or with little) additional processing. In doing so, overall computation requirement is reduced such that latency as well as consumption of processing resources and energy can be reduced. The present technology may be particularly relevant to motion estimation involving motion pyramid.

Another aspect of the present technology provides a non-transitory computer readable storage medium storing software code which when executed on one or more processors performs a method of performing motion estimation for spatially arranged data in a data processor, the spatially arranged data having been previously compressed using a compression algorithm that generates compression meta data representing the spatially arranged data, the method comprising: for a first region of the spatially arranged data: obtaining compression meta data for the first region, the compression metadata comprising smoothness information indicative of a smoothness of the first region; determining a search space size based on the obtained smoothness information, the search space size being a size of a search space for applying a region-matching motion estimation algorithm to the first region to match the first region with a corresponding region in a reference frame within the search space.

A further aspect of the present technology provides a graphics processor comprising: processing circuitry for performing motion estimation for spatially arranged data in a data processor, the spatially arranged data having been previously compressed using a compression algorithm that generates compression meta data representing the spatially arranged data, the processing circuitry being configured to: for a first region of the spatially arranged data: obtain compression meta data for the first region, the compression metadata comprising smoothness information indicative of a smoothness of the first region; determine a search space size based on the obtained smoothness information, the search space size being a size of a search space for applying a region-matching motion estimation algorithm to the first region to match the first region with a corresponding region in a reference frame within the search space.

In some embodiments, the method may further comprise determining whether the first region is smooth based on the smoothness information of the first region, wherein, when it is determined that the first region is smooth, setting a reduced search space as the search space size; or when it is determined that the first region is not smooth, setting an extended search space as the search space size. Based on the smoothness information from the compression meta data, when the region is determined as smooth (e.g. shade), a reduced search space is set whereby a smaller area within a reference space is searched, while the first region may be determined as not smooth (e.g. edge) if the smoothness information for the first region indicates that it does not fulfil a smoothness condition, in which case an extended search space may be set for region matching with respect to the first region. Herein, the terms “reduced” and “extended” are used for purposes of comparison only, and the expressions “reduced search space” and “extended search space” simply refer to the difference in the number of search points when performing region matching motion estimation and may or may not reflect an actual physical area within the spatially arranged data (e.g. a frame).

In some embodiments, the extended search space may be an area within the reference spatially arranged data comprising a plurality of regions adjacent a region at a position corresponding to a position of the first region in the spatially arranged data, and the reduced search space may be a reduced area comprising a portion of the plurality of regions of the extended search space.

The determination of smoothness may be performed in a number of ways. One way may be to determine the smoothness of a region based on the size of the compressed data that forms the region. Thus, in some embodiments, the smoothness information of the first region may comprise a compressed data size of the first region. Another way may be to determine that a region is smooth when the compression meta data (e.g. in the header) indicates that all pixels in the region is of a single color (e.g. in AFBC).

In embodiments where compression data size is used as an indicator of the smoothness of a region, it may be assumed that a smaller size indicates a smoother region. Thus, in some embodiments, the first region may be determined smooth when the compressed data size of the first region is below a size threshold.

In some embodiments, the compression algorithm may be a region-based compression algorithm. The region-based compression algorithm may for example be configured to generate a plurality of randomly accessible compression regions. For example, ARM Frame Buffer Compression (AFBC), ARM Fixed Rate Compression (AFRC), Universal Bandwidth Compression (UBWC), IMGIC, etc.

For some compression schemes, the compression meta data for a region of spatially arranged data may include data that indicates the range of data values that are within the region. Thus, in some embodiments, the smoothness information may comprise region-specific data value range information indicative of a range of data values for a region of the spatially arranged data. For example, in AFBC, the compression meta data of spatially arranged data comprises bit count tree (bctree) data associated with a hierarchical structure representing the array of data values forming the spatially arranged data, and the bctree data indicates a number of bits needed for encoding the differences in data values with respect to a minimum data value within each region, and therefore bctree data is indicative of the range of data values within the region.

In some embodiments, the first region may be determined smooth when the region-specific data value range information of the first region is below a data value range threshold. For example, for AFBC, a threshold may be set for bctree data below which a region is determined as smooth.

For some compression schemes, the compression meta data for a region of spatially arranged data may include data that indicates the position of the region within the spatially arranged data. Thus, in some embodiments, the compression meta data may further comprise position information indicative of a position of a region within the spatially arranged data. For example, in AFBC, the array of data values forming a spatially arranged data may be arranged in a hierarchical tree and the compression meta data of the spatially arranged data includes information of the hierarchical arrangement. In particular, in AFBC, spatially arranged data may be arranged in a minimum value quad-tree (min-tree) having a plurality of levels (e.g. four levels), wherein each subsequent lower level in the hierarchy comprises child nodes of respective parent nodes of the preceding higher level, each child node may be regarded as a smaller sub-region of a larger region represented by the respective parent node. In a min-tree, a parent node is typically represented by the minimum data value amongst the group of data values within a region represented by the parent node, while each child node of the parent node is encoded as a difference in data value with respect to the parent node (i.e. the minimum data value). In such compression schemes, the compression data may comprise data indicative of the position of a region (e.g. represented as a child node) within the hierarchical structure, and therefore the position of the region within the spatially arranged data.

In some embodiments, obtaining compression meta data for the first region may comprise obtaining smoothness information of the first region based on the position information of the first region. Using the position information in the compression meta data of the spatially arranged data, it is possible to identify the relevant smoothness information for a particular region within the spatially arranged data.

In some embodiments, the region-based compression algorithm may generate a plurality of compression regions, and the method may further comprise, when the first region is within a single compression region, obtaining smoothness information for the first region based on smoothness information of the single compression region using position information of the single compression region. For example, in cases where the compression scheme generates a hierarchical representation of the spatially arranged data, each leaf (child) node may represent a specific region within the spatially arranged data. However, when a region of spatially arranged data is selected for motion estimation, this region may or may not coincide with the plurality of regions generated by the compression scheme (compression regions). In cases where the region for which motion estimation is performed is entirely within the same single compression region (e.g. a particular child/leaf node e.g. identified based on the position information of the single compression region), then the smoothness information for the region may be obtained simply by obtaining the smoothness information for the single compression region.

In some cases, the region for which motion estimation is performed may not be entirely within the same single compression region and may e.g. overlap two or more compression regions. In such cases, it may not be sufficient to determine the smoothness of the region using only smoothness information for one of the two or more compression regions. Thus, in some embodiments, the method may further comprise, when the first region overlaps a first compression region and a second compression region, obtaining smoothness information for the first region by comparing smoothness information of the first compression region using position information of the first compression region and smoothness information of the second compression region using position information of the second compression region.

There may be many different suitable ways of using or combining the smoothness information of multiple compression regions to determine the smoothness of a region for motion estimation that overlaps the multiple compression regions. In some embodiments, the first region may be determined to be smooth when a difference between the smoothness information of the first compression region and the smoothness information of the second compression region is below a smoothness threshold.

In some embodiments, the region-based compression algorithm may generate a hierarchical representation representing the plurality of compression regions, each compression region being sub-divided into a plurality of sub-regions, and the position information may comprise a position of a sub-region respective of a compression region within the hierarchical representation.

In some cases, the region for which motion estimation is performed may not be entirely within the same single compression region represented by a child node (a sub-region) and may e.g. overlap two or more sub-regions (child nodes). The two (or more) sub-regions may be represented by respective child nodes that belong to the same parent node representing a compression region higher up in the hierarchy (e.g. determined based on the position information of the two or more sub-regions/child nodes). In such a case, it may be possible to determine the smoothness of the region for motion estimation using the smoothness information of the compression region represented by the parent node. Thus, in some embodiments, the method may further comprise, when the first region overlaps a first sub-region of a compression region and a second sub-region of the compression region, determining that the first sub-region and the second sub-region belong to the same compression region within the hierarchical representation using position information of the first sub-region and the position information of the second sub-region, and obtaining smoothness information for the first region based on smoothness information of said same compression region. In cases where the two or more sub-regions are child nodes of different parent nodes representing different compression regions, then smoothness information of each sub-regions may be used to determine the smoothness of the region for motion estimation.

In some embodiments, applying the region-matching motion estimation algorithm may comprise comparing the first region of the spatially arranged data with data elements within the search space in the reference spatially arranged data to determine a most closely matching region of the reference spatially arranged data within the search space

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

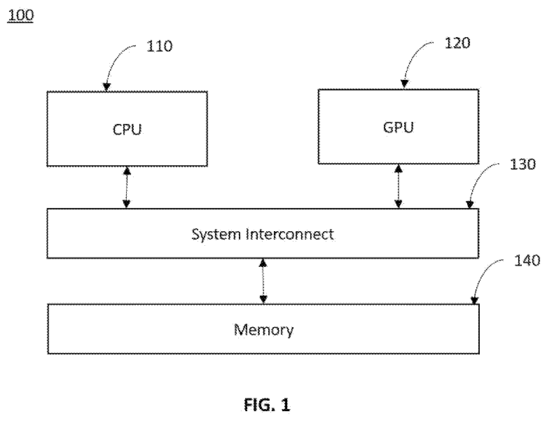

An implementation example is shown in FIG. 1, which schematically shows an exemplary data processing system 100 comprising a CPU 110 and a GPU 120 in communication with a shared memory 140 via an interconnect 130. Herein, the CPU 110 and GPU 120 may also be referred to as processing elements, processors, or cores, and each comprises processing circuitry to execute instructions. The instructions may be stored in memory 140, and the processing elements CPU 110 and GPU 120 may be configured to perform operations on data stored in memory 140 when executing instructions.

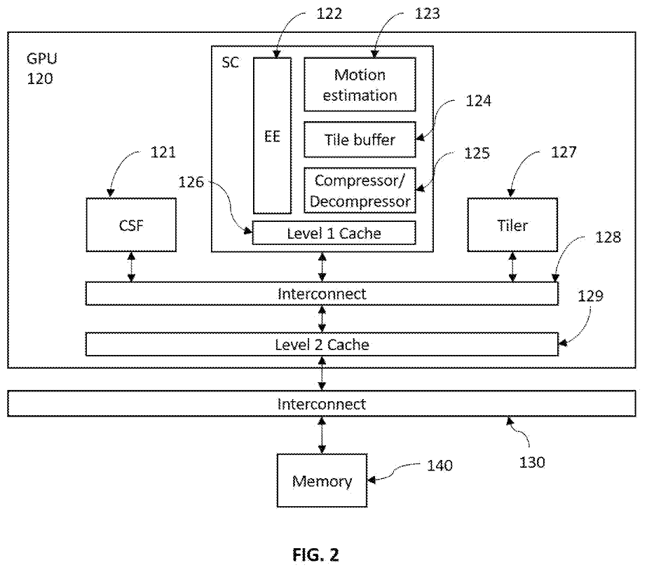

FIG. 2 shows an exemplary graphics processor GPU 120 suitable for implementing the present technology. The GPU 120 is connected via an interconnect 130 to memory 140 (e.g. DDR-SDRAM, Double Data Rate Synchronous Dynamic Memory) e.g. via a Dynamic Memory Controller (DMC) (not shown). Data structures (e.g. command stream) generated by a host processor (CPU) (e.g. CPU 110) that are written to memory 140 are executed by the GPU 120.

The GPU 120 comprises an interconnect 128 that communicatively couples various units within the GPU 120, which includes command stream front end CSF 121, shader core SC, and tiler 127.

The GPU 120 further comprises level 2 cache 129 that can be used to cache data access from the memory 140, and/or generated by CSF 121, SC, tiler 127, to reduce the bandwidth of the memory 140 bandwidth, reduce memory latency, and minimise energy.

The tiler 127, e.g. in a tile-based GPU, can be used to divide up the primitives forming a frame into bins (or tiles) to enable the SC can process each tile separately.

The CSF 121 (Command Stream Front end) reads a command via the internal interconnect 128, the level 2 cache 129, and the external interconnect 130 from the memory 140. For example, the command may request the GPU 120 to perform processing work (a job). The CSF 121 may then break up the requested job into tasks, and the tasks may then be allocated to the (one or more) SC to be processed. In the present example, only one SC is shown; however, a GPU may comprise (and typically does) a plurality of SCs.

The tasks may for example include tile processing, (generic), compute processing, fragment processing, neural processing (e.g. machine learning), and/or motion estimation. The SC accepts a task from the CSF 121 and execute the task accordingly. For example, tile processing, compute processing, and fragment processing may be executed on the programmable execution engine EE 122. Tile processing, compute processing, fragment processing and neural processing may make use of the level 1 cache 126 to cache instructions and data as required.

In a tile-based GPU, fragment processing is performed region (tile) by region, and the results of tile processing are written to a tile buffer 124. When fragment processing has completed, the tile region that has been processed is compressed by a compressor/decompressor 125, and written to memory 140 via the internal interconnect 128, the level 2 cache 129, and the external interconnect 130.

Fragment processing may make use of a previously written compressed tile buffer in the memory 140. This previously written compressed region is fetched from the memory 140, via the external interconnect 130, the level 2 cache 129, and the internal interconnect 128, and decompressed using the compressor/decompressor 125 and written into the tile buffer 124 for use.

In some embodiments, the CSF 121 may receive a command to perform motion estimation. The CSF 121 may then send an associated task to the (one or more) SC. The SC then sends the task to be executed to a motion estimation engine 123, which requests data to be fetched from the memory 140. The memory region that contains the required data may be compressed, which can be decompressed by the compressor/decompressor 125. In some embodiments, the motion estimation engine 123 may be provided with associated memory to buffer the contents of the memory region. In other embodiments, the contents may alternative be stored in, and accessed from, the tile buffer 124. In further embodiments, the contents may be stored in the level 1 cache 126.

In an alternative embodiment, motion estimation tasks may send a program to the execution engine EE 122 to be executed. The (shader) program executed by the execution engine EE 122 contains instructions to cause (via a message) the motion estimation engine 123 to perform motion estimation operation.

Motion vectors are used in a variety of graphics processing algorithms and techniques, for example when performing frame rate uprate conversion, image enhancement, super resolution, temporal anti-aliasing (TAA), denoising (e.g. ray-trace denoising), checker board rendering (CBR), and/or in virtual/augmented/extended/mixed reality (VR/AR/XR/MR), e.g. for Asynchronous Space Warp (ASW), applications. The required motion vectors may not be provided by the application, in which case these motion vectors are derived by comparing an image frame to be rendered with a reference image frame using motion estimation.

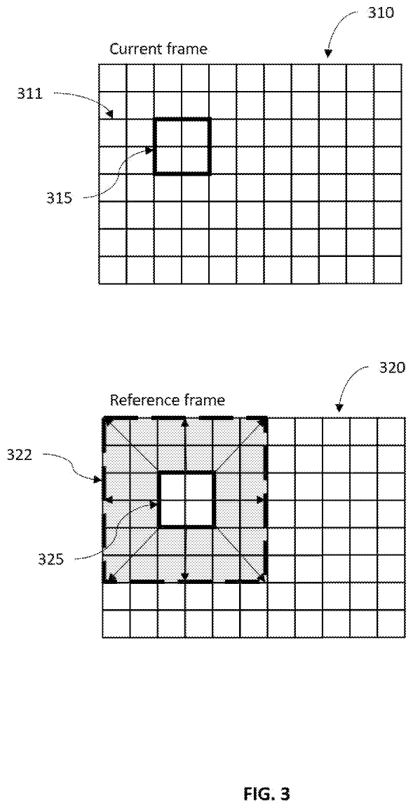

One technique for motion estimation is the use of a block matching algorithm, in which the current frame is processed region by region as discrete non-overlapping macroblocks. An exemplary block-matching motion estimation technique is illustrated in FIG. 3, showing a current frame 310 comprising a plurality of data elements 311 (e.g. pixels). A region, or macroblock, 315 within the current frame 310 is compared with a corresponding region (or macroblock) 325 within a reference frame 320. A reference frame may for example be a frame preceding or succeeding the current frame 310 in a sequence of frames. In addition, the region 315 in the current frame 310 is compared with data elements within a search space 322 (shown in grey) in the reference frame around the corresponding region 325. The region within the search space 322 that matches most closely to the region 315 is determined. Various techniques may be used to determine a matching region including mean absolute difference (MAD), sum of absolute differences (SAD), and mean square error (MSE). The region within the reference frame 320 with the smallest difference compared to the region 315 is determined as the matching region. The position of the matching region within the reference frame 320 is then used to determine the motion vector of the current region 315.

The search space 322 for the current region 315 may be set as desired, for example the search space 322 may include up to p data elements (e.g. pixels) on each of the four sides of the corresponding region 325 in the reference frame 320. The value of p may be regarded as a search parameter and larger motions is expected to require a larger p value in order to locate a matching region, and therefore requires more computation power.

To reduce the computation requirements for motion estimation, an approach has been proposed in which edge detection is performed prior to region matching to determine or select an appropriate search space around the corresponding region in the reference frame. Edge information may be regarded as a sharp change in intensity (or other parameters such as texture and depth) in the spatial domain (a steep gradient or low smoothness). In one approach, the difference between e.g. the two vertical halves of the current region and the difference between e.g. the two horizontal halves of the current region may be determined, and when the sum of these differences is below a predetermined threshold, it is considered that the current region contains no significant gradient (high smoothness) and the current region is classified as shade (or smooth); otherwise the current region is classified as edge (low smoothness or not smooth). Other methods of determining or classifying intensity gradient (smoothness) in a region is of course possible.

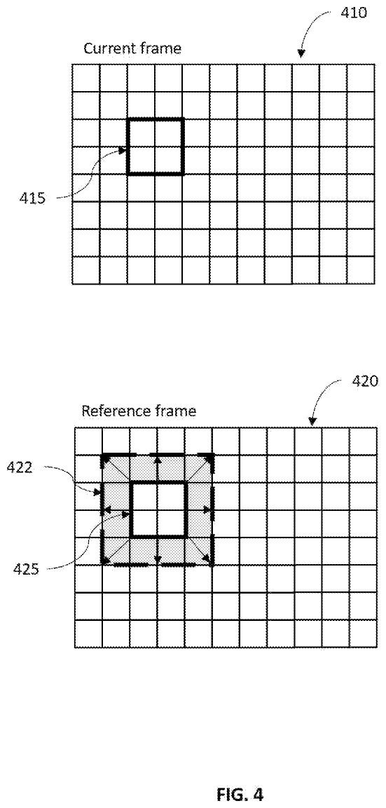

A shade region has a high probability to move in the same direction as regions adjacent the shade region. Based on this assumption, when the current region is classified as shade, the search space for the current region may be reduced so as to conserve computation resources, increase energy efficiency, and reduce latency. FIG. 4 illustrates a reduced search space used in a region-matching motion estimation technique. If a current region 415 of a current frame 410 is classified as shade, a reduced search space 422 around a corresponding region 425 in a reference frame 420 may be set. As can be seen in FIG. 4, the reduced search space 422 covers a smaller area compared to the search space 325 in the reference frame 320 in FIG. 3. A reduced search space refers to a search space that includes only a portion of the search space used for an edge region. Other ways of reducing the search space for a current region is therefore possible as desired, such as setting the search space to cover only an area above, below, to the left and/or to the right of a corresponding region.

While this approach reduces the computation requirement for some portions of a frame during motion estimation and therefore reduces the overall latency, such an approach still requires a pre-processing step for each region of the frame to determine if a region is edge or shade. This pre-processing step requires computation resources and energy and contributes to the overall latency of motion estimation. Moreover, additional hardware logic may be required in order to perform the pre-processing. Thus, there is scope to improve the efficiency of motion estimation.

The Applicant has recognized that, in graphics processing, frames are generally compressed to minimize bandwidth requirements, and that frame compression meta data generally contains information that indicates the smoothness of different regions of the frame. Some compression schemes may be region based, which allows each region of a frame to be compressed or decompressed independently of other regions. The use of region-based compression schemes allow each region of a frame to be compressed or decompressed in any order, thereby allowing random access on a region basis. The smoothness information of a region may therefore be used, in a similar way to classifying a region as edge or shade, to set a search space for applying motion estimation to the region. Thus, the determination of a search space for a region of a frame may be performed by simply reading from the compression meta data smoothness information for that region without (or with little) additional processing. In doing so, overall computation requirement is reduced such that latency as well as consumption of processing resources and energy can be reduced.

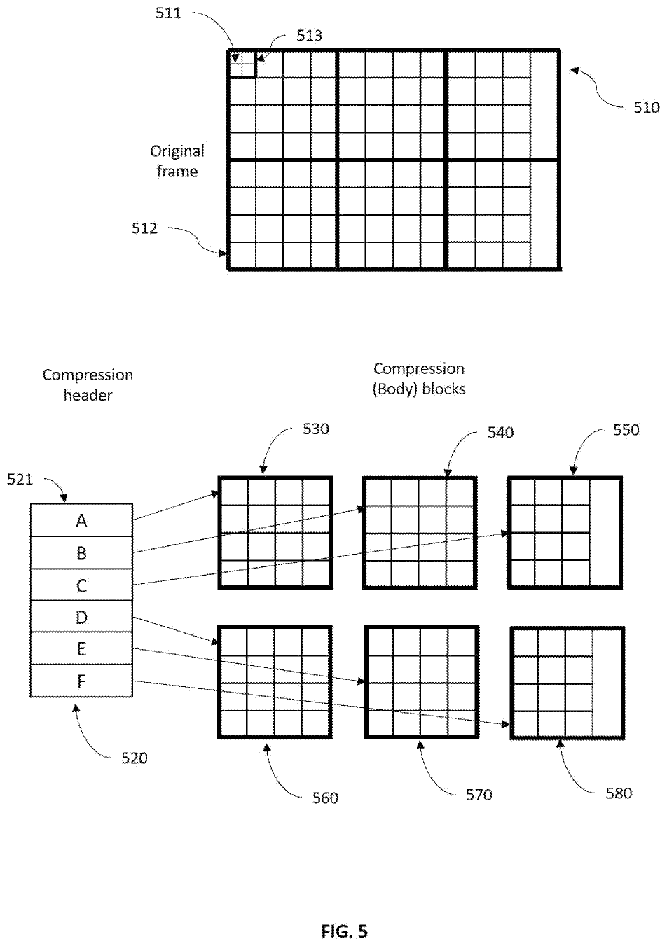

FIG. 5 illustrates an exemplary region-based compression scheme that generates compression meta data that can be used for implementing the present technology. FIG. 5 schematically shows an array of data elements 511 forming a frame 510 in its original uncompressed form that is to be encoded and compressed. The data elements contain data entries at a plurality of positions within the array, and each data entry (position) in the array indicates e.g. a set of color values (e.g. RGB (Red, Green, Blue) values, RGBA (Red, Green, Blue, Alpha), or YUV (Luminance, Chroma)) to be used for displaying the frame e.g. on a display.

As shown in FIG. 5, to compress the frame 510, the frame 510 is first divided into a plurality of non-overlapping, equal-sized and uniform blocks 512, each (compression) block corresponding to a particular region of the frame 510. While FIG. 5 shows the blocks 512 as squares, in other embodiments, other shapes and sizes blocks may be used as desired. In the present example, each block 512 corresponds to a block of 16×16 elements (positions, e.g. pixels) within the frame 510. In some examples, each block 512 may be further sub-divided into a set of sixteen non-overlapping, equal-sized and uniform sub-blocks 513. In the present example, as each block 512 corresponds to a 16×16 elements within the frame 510, each sub-block 513 accordingly corresponds to a 4×4 data element region within the block 512.

In an example, to compress the frame 510, firstly a header data block 521 is generated for each block 512 of the frame 510. A compression header 520 comprising all header data blocks 521 of the frame 510 may for example be stored in a header buffer in memory. FIG. 5 shows the positions of the header data blocks 521 in the compression header 520 for body (compression) blocks 530, 540, 550, 560, 570, 580 that the frame 510 is divided into, wherein each body block 530, 540, 550, 560, 570, 580 has a corresponding header data block 521 in the compression header 520. It should be noted that a compression block needs not to be filled by frame elements, depending on the size and shape of the frame and the size and shape of a block. For example, as can be seen in FIG. 5, the two blocks 550, 580 on the right side of the frame are each only partially filled.

In general, a header (e.g. header A, B, C, D, E, F) comprises meta data (e.g. meta data indicating if the region with which it associates has only a single color) and a pointer to an associated body block (e.g. blocks 530, 540, 550, 560, 570, 580), wherein a body block contains the compressed data for that region. As well as generating a respective header data block 521 for each block 530, 540, 550, 560, 570, 580, the compression scheme may also generate header data for each sub-block 513, which may be stored in or with the associated body block.

Examples of such region (block)-based compression schemes include ARM Frame Buffer Compression (AFBC), ARM Fixed Rate Compression (AFRC), Universal Bandwidth Compression (UBWC), IMGIC, etc.

In the embodiments, the header data blocks A, B, C, D, E, F for respective compression blocks 530, 540, 550, 560, 570, 580 comprises smoothness information that is indicative of the smoothness of the corresponding block. This smoothness information may be in a number of different forms.

A simple form of smoothness information may be a value (compressed data size) that represents the size of the compressed data of a block found in compression meta data for the block. In this case, a small compressed data size for a block may be indicative of a region of a frame represented by the block being generally smooth, while a large compressed data size for the block may be indicative of the region having significant contrast (therefore not smooth). To determine whether a block is smooth using compressed data size information, a size threshold may be set below which the block is deemed smooth (e.g. shade) and above which the block is deemed not smooth (e.g. edge).

Another example of smoothness information may be compression meta data in the header data, e.g. generated using AFBC, which gives an indication when all the data elements within a block is of a single color. This meta data may be used as an indication that a region represented by the block is smooth.

In embodiments in which compression schemes that generate compression meta data that comprises data value range information, such as AFBC, are used for frame compression, the data value range information may be used as smoothness information.

In compression schemes such as AFBC, frame data is arranged hierarchically and the compression meta data of the frame includes information of the hierarchical arrangement and information indicative of a data value range with respect to each node of the hierarchy. For example, in AFBC, frame data is arranged in a minimum value quad-tree (min-tree) having four levels, wherein at level 1, a frame may be divided into components (e.g. red, green, blue and alpha channels), then, at level 2, each component may be divided into plural compression blocks (e.g. 16×16 data element block). At level 3, each compression block may be further sub-divided into plural sub-blocs (e.g. 4×4 sub-blocks each comprising 4×4 data elements), and at level 4, each sub-block may be divided into individual 2×2 data elements.

In a min-tree, a parent node is typically the minimum data value amongst a group (e.g. each block) of data values while each child node is encoded as a difference in data value with respect to the parent node. In addition to information indicative of the hierarchical arrangement of frame data, the compression meta data generated further includes information that indicates the range of data values amongst a group, e.g. a node, a block or a sub-block. In AFBC, this data value range information is provided in the form of a bit count tree (bctree) associated with the min-tree, which indicates the number of bits to be used for encoding the differential and is therefore indicative of the size of the differences amongst the child nodes of a particular parent node. In other words, bctree data for a portion of the hierarchy (e.g. a compression block) indicates a smoothness of the features in a region of the frame represented by that portion.

To determine whether a block (or sub-block) is smooth based on data value range information (e.g. bctree data), a range threshold may be set below which a block is deemed smooth (e.g. shade), and above which the block is deemed not smooth (e.g. edge). Then, using position information such as hierarchical information (e.g. min-tree) in the meta data, it is possible to identify the position of a block within a frame, and based on the data value range information (e.g. bctree) in the meta data for that block, it is possible to determine the smoothness of the block.

It should be noted that the size and division of compression blocks need not match the size and division of a search block (region) for a given motion estimation algorithm. There may, therefore, be instances when a region in a current frame to be searched (for block matching) does not fall completely within a compression block, and the region may overlap two (or more) compression blocks in different proportions. In such cases, the present approach may be implemented to only determine that a region in the current frame is smooth (e.g. shade) if both compression blocks that the region overlaps are indicated as smooth by their respective compression meta data. If one or both of the compression blocks are indicated as not smooth, the region is determined as not smooth (e.g. edge).

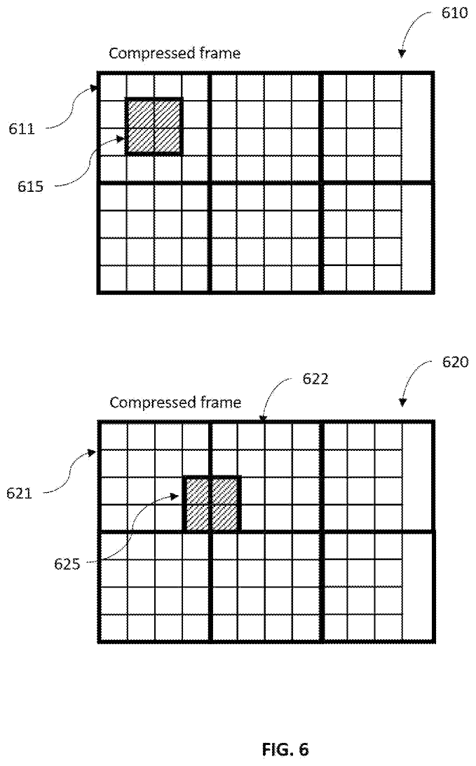

FIG. 6 illustrates an example in which a search block 615, i.e. a region within a current frame 610 to be searched for region matching with a reference frame (not shown), is entirely within a compression block 611. In this case, smoothness information (e.g. compressed data size, data value range) of the block 611 may be read from the compression meta data for the block 611, e.g. using position information of the block 611, to determine if the search block 615 is smooth. If the smoothness information for the block 611 indicates that the block 611 is smooth, then the search block 615, which is entirely within the compression block 611, is determined to be smooth.

In a second example in FIG. 6, a search block 625, i.e. a region within a current frame 620 to be searched for region matching with a reference frame, overlaps a first compression block 621 and a second compression block 622. In this case, smoothness information of both blocks 621 and 622 is read respectively from the compression meta data for the blocks 621, 622 to determine if the search block 625 is smooth. For example, the present approach may be applied such that the search block 625 is determined smooth only when smoothness information of the compression blocks 621, 622 indicates that both compression blocks 621, 622 are smooth; otherwise the search block 625 is deemed not smooth (e.g. edge).

In either example, if the search block 615, 625 is determined to be smooth, a reduced search space is set for performing motion estimation on the search block 615, 625; otherwise, a normal (or extended) search space is set.

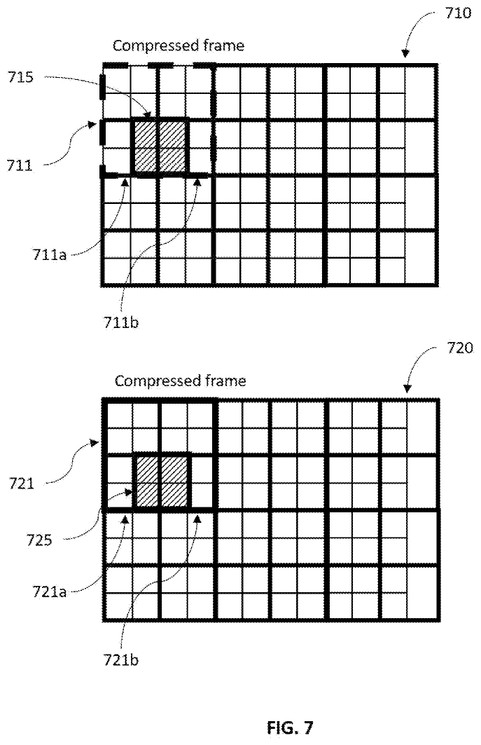

There may be instances when a search block overlaps two (or more) sub-blocks of a compression block, or a sub-block from two (or more) compression blocks. In such cases, it may be desirable to only consider the relevant sub-blocks from the respective compression block(s) that are covered by the search block. FIG. 7 illustrates such an example.

In a first example shown in FIG. 7, a search block 715 overlaps a first sub-block 711a and a second sub-block 711b of a compression block 711. In the present embodiment, smoothness information included in compression meta data for each compression block and each sub-block comprises data value range information (e.g. bctree data). In the present embodiment, a comparison may be made between the data value range information between the two adjacent blocks sub-blocks 711a, 711b (e.g. located based on position information such as min-tree data) to determine whether a region across the two adjacent sub-blocks 711a, 711b is smooth, thus whether a region covered by the search block 715 in the frame 710 is smooth or not.

For example, if the first sub-block 711a has a bctree of 2-bit while the second sub-block 711b also has a bctree of 2-bit, it may be deduced that both sub-blocks 711a, 711b are smooth and therefore the search block 715 may be classified as smooth (shade). On the other hand, if the bctree data of the first sub-block 711a indicates a minimum value of 10 while the bctree data of the second sub-block 711b indicates a minimum value of 50, it may be deduced that there is a significant gradient between the two sub-blocks 711a, 711b and therefore the search block 715 may be classified as not smooth (edge).

In a hierarchical arrangement, smoothness information (e.g. data value range information) for a higher-level node (e.g. a compression block) can be used to determine the overall smoothness of the lower-level nodes (e.g. the sub-blocks of the compression block) of the higher-level node. Thus, in a second example, if a search block 725 in a frame 720 overlaps a first sub-block 721a and a second sub-block 721b, both being sub-blocks of a compression block 721, smoothness information (e.g. data value range information (bctree)) may be read from the compression meta data of the compression block 721, and the smoothness information for the compression block 721 may be used to determine the smoothness of the search block 725.

Again, to determine whether a block (or sub-block) is smooth based on data value range information (e.g. bctree data), a range threshold may be set below which a block is deemed smooth (e.g. shade), and above which the block is deemed not smooth (e.g. edge). If a search block is determined to be smooth, a reduced search space may be set for performing motion estimation on the search block; otherwise, a normal (or extended) search space is set.

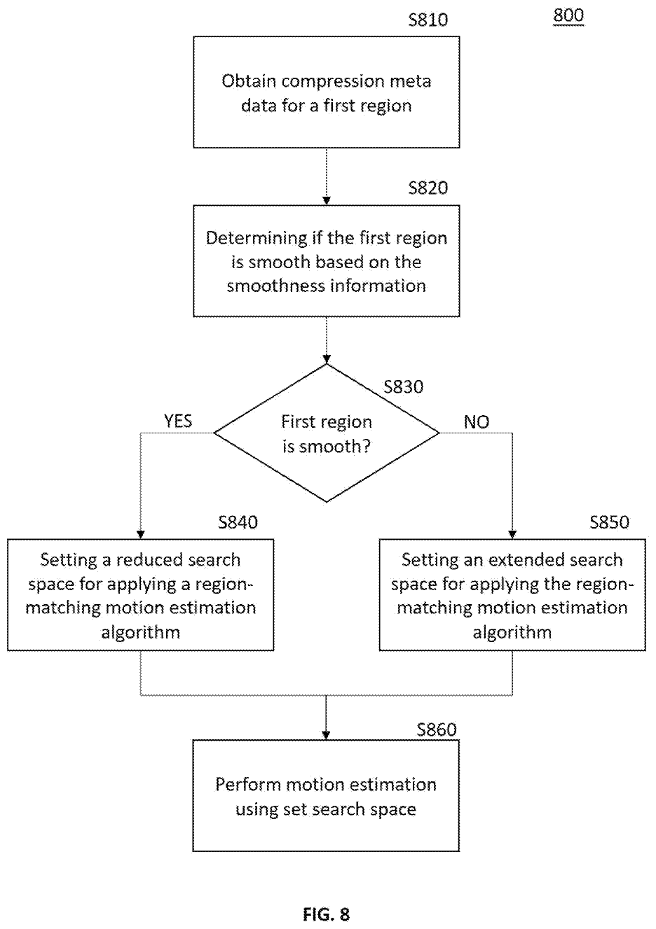

FIG. 8 shows an exemplary method 800 of performing motion estimation for a frame according to an embodiment. In the embodiment, the frame has been previously compressed using a compression algorithm that generates compression meta data representing data of the frame for example as described above. The method begins at S810, in which, for a first region of the frame, compression meta data for the first region is obtained. The compression metadata comprises, according to the embodiment, smoothness information indicative of a smoothness of the first region.

At S820, it is determined whether the first region is smooth based on the obtained smoothness information of the first region.

At S830, if it is determined that the first region is smooth (YES path), a reduced search space is set at S840 for applying a region-matching motion estimation algorithm to the first region.

If at S830, it is determined that the first region is not smooth (NO path), an extended search space is set at S850 for applying the region-matching motion estimation algorithm to the first region.

Then at S860, the region-matching motion estimation algorithm is applied, using the appropriately set search space, to the first region to match the first region with the corresponding region in the reference frame within the extended search space.

Through using frame compression meta data containing information that indicates the smoothness of different regions of the frame, a region may be straightforwardly and efficiently classified as being smooth or not without much (or any) additional processing. The determination of smoothness of a region may then be used to set an appropriate search space for applying motion estimation to the region. Thus, a reduced search space may be applied to one or more region of a frame without (or with little) incurring additional processing to reduce the computation requirement for the determination of search space as well as the overall computation requirement for motion estimation, such that latency due to motion estimation may be reduced.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method of performing motion estimation for spatially arranged data in a data processor, the spatially arranged data having been previously compressed using a compression algorithm that generates compression meta data representing the spatially arranged data, the method comprising:
for a first region of the spatially arranged data:
obtaining compression meta data for the first region, the compression metadata comprising smoothness information indicative of a smoothness of the first region; and
determining a search space size based on the obtained smoothness information, the search space size being a size of a search space for applying a region-matching motion estimation algorithm to the first region to match the first region with a corresponding region in reference spatially arranged data within the search space.

2. The method of claim 1, further comprising determining whether the first region is smooth based on the smoothness information of the first region, wherein,
when it is determined that the first region is smooth, setting a reduced search space as the search space size; or
when it is determined that the first region is not smooth, setting an extended search space as the search space size.

3. The method of claim 2, wherein the extended search space is an area within the reference spatially arranged data comprising a plurality of regions adjacent a region at a position corresponding to a position of the first region in the spatially arranged data, and the reduced search space is a reduced area comprising a portion of the plurality of regions of the extended search space.

4. The method of claim 1, wherein the smoothness information of the first region comprises a compressed data size of the first region.

5. The method of claim 4, further comprising determining whether the first region is smooth based on the smoothness information of the first region, wherein the first region is determined smooth when the compressed data size of the first region is below a size threshold.

6. The method of claim 1, wherein the compression algorithm is a region-based compression algorithm configured to generate a plurality of randomly accessible compression regions.

7. The method of claim 6, wherein the smoothness information comprises region-specific data value range information indicative of a range of data values for a region of the spatially arranged data.

8. The method of claim 7, further comprising determining whether the first region is smooth based on the smoothness information of the first region, wherein the first region is determined smooth when the region-specific data value range information of the first region is below a data value range threshold.

9. The method of claim 6, wherein the compression meta data further comprises position information indicative of a position of a region within the spatially arranged data.

10. The method of claim 9, wherein obtaining compression meta data for the first region comprises obtaining smoothness information of the first region based on the position information of the first region.

11. The method of claim 6, the method further comprising, when the first region is within a single compression region, obtaining smoothness information for the first region based on smoothness information of the single compression region using position information of the single compression region.

12. The method of claim 11, further comprising, when the first region overlaps a first compression region and a second compression region, obtaining smoothness information for the first region by comparing smoothness information of the first compression region using position information of the first compression region and smoothness information of the second compression region using position information of the second compression region.

13. The method of claim 12, further comprising determining whether the first region is smooth based on the smoothness information of the first region, wherein the first region is determined to be smooth when a difference between the smoothness information of the first compression region and the smoothness information of the second compression region is below a smoothness threshold.

14. The method of claim 11, wherein the region-based compression algorithm generates a hierarchical representation representing the plurality of compression regions, each compression region being sub-divided into a plurality of sub-regions, and the position information comprises a position of a sub-region respective of a compression region within the hierarchical representation.

15. The method of claim 14, further comprising, when the first region overlaps a first sub-region of a compression region and a second sub-region of the compression region, determining that the first sub-region and the second sub-region belong to the same compression region within the hierarchical representation using position information of the first sub-region and the position information of the second sub-region, and obtaining smoothness information for the first region based on smoothness information of said same compression region.

16. The method of claim 1, wherein applying the region-matching motion estimation algorithm comprises comparing the first region of the spatially arranged data with data elements within the search space in the reference spatially arranged data to determine a most closely matching region of the reference spatially arranged data within the search space.

17. A non-transitory computer readable storage medium storing software code which when executed on one or more processors performs a method of performing motion estimation for spatially arranged data in a data processor, the spatially arranged data having been previously compressed using a compression algorithm that generates compression meta data representing the spatially arranged data, the method comprising:
for a first region of the spatially arranged data:
obtaining compression meta data for the first region, the compression metadata comprising smoothness information indicative of a smoothness of the first region; and
determining a search space size based on the obtained smoothness information, the search space size being a size of a search space for applying a region-matching motion estimation algorithm to the first region to match the first region with a corresponding region in reference spatially arranged data within the search space.

18. A graphics processor comprising:
processing circuitry for performing motion estimation for spatially arranged data, the spatially arranged data having been previously compressed using a compression algorithm that generates compression meta data representing the spatially arranged data, the processing circuitry being configured to:
for a first region of the spatially arranged data:
obtain compression meta data for the first region, the compression metadata comprising smoothness information indicative of a smoothness of the first region; and
determine a search space size based on the obtained smoothness information, the search space size being a size of a search space for applying a region-matching motion estimation algorithm to the first region to match the first region with a corresponding region in reference spatially arranged data within the reduced search space.

19. The graphics processor of claim 18, wherein the processing circuitry is further configured to:
determine whether the first region is smooth based on the smoothness information of the first region, and,
when it is determined that the first region is smooth, to set a reduced search space as the search space size; or
when it is determined that the first region is not smooth, set an extended search space as the search space size, wherein the extended search space is an area within the reference spatially arranged data comprising a plurality of regions adjacent a region at a position corresponding to a position of the first region in the spatially arranged data, and the reduced search space is a reduced area comprising a portion of the plurality of regions of the extended search space.

20. The graphics processor of claim 19, wherein the smoothness information of the first region comprises a compressed data size of the first region, the processing circuitry being configured to determine the first region is smooth when the compressed data size of the first region is below a size threshold.

21. The graphics processor of claim 19, wherein the compression algorithm is a region-based compression algorithm configured to generate a plurality of randomly accessible compression regions, and the smoothness information comprises region-specific data value range information indicative of a range of data values for a region of the spatially arranged data, the processing circuitry being configured to determine the first region is smooth when the region-specific data value range information of the first region is below a data value range threshold.
